(19) United States
(12) Patent Application Publication
(10) Pub. No.: US 2008/0211571 A1
(43) Pub. Date: Sep. 4, 2008

(54) Device For Passive Stabilization of Supply Voltages of a Semiconductor Element

(76) Inventors: Vinko Marolt, Reutlingen (DE); Ralf-Eckhard Stephan, Munsingen (DE)

Correspondence Address: KENYON & KENYON LLP, ONE BROADWAY, NEW YORK, NY, 10004, US

(21) Appl. No.: 11/631,657

(22) PCT Filed: May 31, 2005
(86) PCT No.: PCT/EP05/52472

§ 371 Date: Dec. 14, 2007

(30) Foreign Application Priority Data
Jul. 7, 2004 (DE) 102004032708.4

(51) Int. Cl. G05F 1/10

(52) U.S. Cl. 327/537

(57) ABSTRACT

In a device for passive stabilization of voltage supplies of a semiconductor element, regions made of a second conductivity type are embedded in a first layer of a first conductivity type within lateral regions, which are used for the wiring of standard cells of components. Barrier layers whose capacitances are used for supporting supply voltages are formed on the boundary surfaces. For this purpose, the regions of the second conductivity type are connected either to first substrate of the same conductivity type or to troughs within standard cells, which have the second conductivity type.

### FIELD OF THE INVENTION

The present invention relates to a device for passive stabilization of voltage supplies of a semiconductor element.

### BACKGROUND INFORMATION

For cost reasons, individual work steps of digital circuit development and design are automated in the manufacturing technology normally used today. In a first step, function and circuit design are formulated in abstract terms. The abstract formulation of the circuit is transferred to a physical implementation in further steps, using libraries. For this purpose, the libraries include physical representations of frequently occurring subcircuits of the abstract circuits. A standard cell is a basic subcircuit. A typical standard cell includes two complementary transistors, which are arranged in a “push-pull” configuration. The transistors may be designed using CMOS technology or bipolar technology. The standard cell is supplied with power via a voltage source and a ground associated with the voltage source.

FIG. 4 shows a typical conventional design of such a standard cell 10. The two complementary transistors, an n-channel type 23 and a p-channel type 33, are shown. The placements, dimensions, and doping characteristics of the required individual structures are typically defined in a library. The embodiment shown of the library standard cell provides for the embedding of two p-doped regions 20 and 22 into an n-doped first semiconductor layer 3 and applying a gate structure 21 on the uppermost surface 100 of n-doped first layer 3 for an n-channel CMOS transistor 23.

Furthermore, two n-doped regions 24 and 25 are provided on either side of the n-channel transistor. A p-doped trough 36 is introduced into n-doped first layer 3 next to n-doped region 25. Two n-doped regions 30 and 32, which form the drain and source of the p-channel transistor, are introduced into this p-doped trough. Furthermore, a gate structure 31 is applied to uppermost surface 100 between the two n-doped regions 30 and 32. Furthermore, the library provides for positive power supply V_{DD} to be brought into contact with n-doped region 24, and ground connection Gnd with the p-doped trough.

Individual standard cells 10 are linked by wires 60 through 63 in such a way that the desired functionality of the circuit is achieved. Wires 60 through 63 are run both over the standard cells used and in regions 11 laterally separated from standard cells 10. Only wires that are not blocked by structures within the standard cells may be used over the standard cells, while in the spatially separated regions any wiring levels may be used without limitations.

An increased current briefly flows between V_{DD} and ground Gnd during each switching operation of a standard cell 10. This increased current is the result of a cross-current which arises due to the simultaneous switching of n-channel transistor 23 and p-channel transistor 33 into the conducting or blocked states and/or due to the recharging of the parasitic capacitors in standard cell 10. This current must be made available by voltage supply V_{DD} and should be dischargeable via ground connection Gnd. Since the leads of both the voltage supply and the ground have an inductivity, a voltage pulse arises in the supply lines when the current flow through a standard cell 10 increases or decreases. This means that a voltage peak occurs in the supply lines whenever a standard cell 10 is switched. Since, in digital circuits, a plurality of standard cells 10 switch synchronously, high-amplitude voltage peaks occur in the supply lines. The circuits must be designed in such a way that voltage peaks remain below a critical value at which they do not impair the functionality of the circuit. A plurality of devices is known for limiting the voltage peaks to a value less than a critical value.

Large-surface supply lines reduce the amplitude of the voltage peaks due to their low inductivity. The need for a larger surface is, however, disadvantageous with regard to the desired higher integration density of the components.

Additional capacitors, known as back-up capacitors, are connected to supply lines V_{DD} and to ground lines Gnd. In a conventional method, these are placed outside an IC or a component, possibly in the proximity of the supply line or ground lines. For cost reasons, however, installation of further components is undesirable; it also reduces the integration density achievable on a pc board.

Capacitors may be integrated within an IC in the proximity of the components that cause the voltage peaks. The manufacture of these backup capacitors requires separate processing steps, which makes the ICs more expensive. In order to circumvent this disadvantage by not introducing additional process steps, additional room must be provided for the capacitors within the ICs. This in turn reduces the achievable integration density and makes the ICs more expensive.

Furthermore, it is known that a barrier layer capacitance arises on a boundary surface 102 (see FIG. 4) between a p-doped substrate 1 and a highly n-doped buried layer 2. This barrier layer capacitance is connected to the positive voltage supply V_{DD} via a vertical connection 40 made of an n-doped material. Connection 40 has low inductivity due to its reduced length. Furthermore, the barrier layer has a high capacitance due to large boundary surface 102. Due to the two above-mentioned facts, the voltage peaks on positive voltage supply V_{DD} are effectively suppressed. The disadvantage is that support of only the positive voltage supply is achieved in this way. The np junction of n-doped buried layer 2 with the p-doped substrate, which blocks the DC components of positive voltage supply V_{DD}, is conductive due to the polarity of the ground. The ground therefore cannot be connected to the buried n-doped layer and to the capacitance of boundary layer 102.

An object of the present invention is to implement an additional backup capacitor within a semiconductor element, which may be integrated without requiring additional lateral space.

### SUMMARY

Some advantages of the device according to the present invention are that stabilization of the ground supply and/or the voltage supply of standard cells of a semiconductor element may be achieved. The semiconductor element has a first lateral region for standard cells having active components, which is separated from a second lateral region, in which the standard cells are wired together. A standard cell has at least one transistor of a first channel type and at least one transistor of a second channel type. The standard cell has a first contact which is connected with one polarity of a voltage supply. This first contact is conductively connected to a first layer, which has a semiconductor substrate of a first conductivity type in which at least one of the transistors of the first channel type is embedded. A second polarity of the voltage supply is connected to a second contact of the standard cell. This contact is conductively connected to a trough, which has a semiconductor material of a second conductivity type. At least one of the transistors of the second channel type is introduced into this trough. A buried layer which has the first conductivity type is embedded directly between the first layer and a substrate which has a semiconductor material of a second conductivity type. The standard cells are wired in the second lateral regions. One or more support regions of a first and/or second type having the second conductivity type is/are embedded in the first layer within the second lateral region. The support regions of the first type are directly adjacent to the trough having the second conductivity type. The barrier layer capacitance, which is formed between the first support regions and the first layer, is added to the barrier layer capacitance between the trough and the first layer. The second support layers are connected to the substrate having the second conductivity type via a vertical connection and are not in contact with the trough. The capacitance of the barrier layer between the second support layers and the first layer is connected to the large charge reservoir and the associated stable potential of substrate 1 and thus stabilizes the potential of first layer 3.

According to one example embodiment of the present invention, the first stabilization regions and/or the second stabilization regions have a large surface. A large surface provides a large barrier layer capacitance and thus proper stabilization of the voltage supplies.

According to one example embodiment of the present invention, the first stabilization regions and/or the second stabilization regions are to be equipped with a plurality of plates. The plates may be manufactured using conventional structuring methods and advantageously increase the surface area of the stabilization regions.

According to one example embodiment of the present invention, the stabilization regions are buried in the first layer. This increases the surface area of the stabilization regions, while capacitive effects between the wiring and the barrier layer capacitances are reduced due to the increased distance.

According to a further example embodiment of the present invention, at least one of the stabilization regions is directly connected to a third contact which is connected to the second polarity of the voltage supply.

The capacitance of a barrier layer increases with the dopant concentration of the stabilization regions. Therefore, another example embodiment of the present invention provides for a high dopant concentration in the stabilization regions.

According to another embodiment of the present invention, the first polarity of the voltage supply is positive and the second polarity represents the ground.

### BRIEF DESCRIPTION OF THE DRAWINGS

FIG. 1 schematically shows a partial section of an example embodiment of the present invention.

FIG. 2 schematically shows a partial section of another example embodiment of the present invention.

FIG. 3 schematically shows a partial section of another example embodiment of the present invention.

FIG. 4 schematically shows a conventional design of a standard cell.

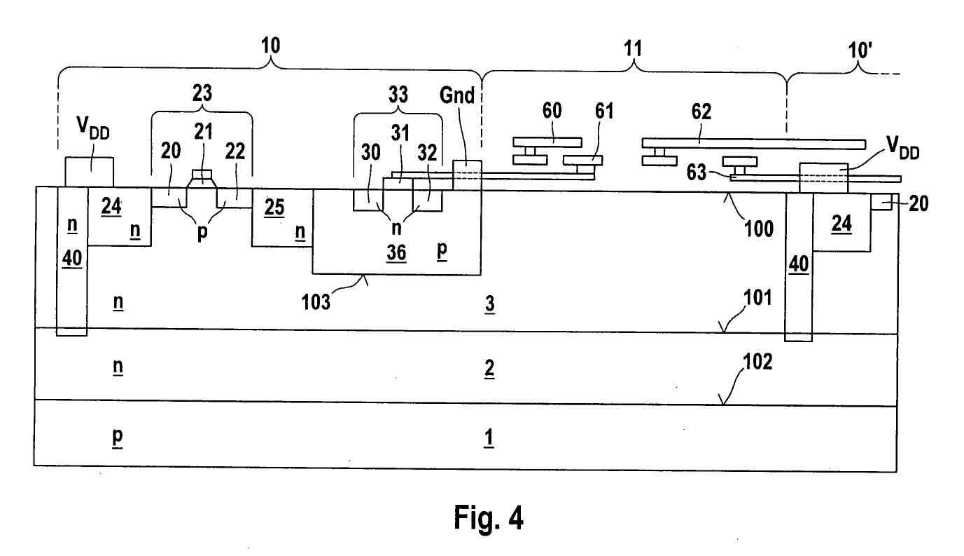

### DETAILED DESCRIPTION

In the figures, the same reference symbols identify the same components or components having an identical function.

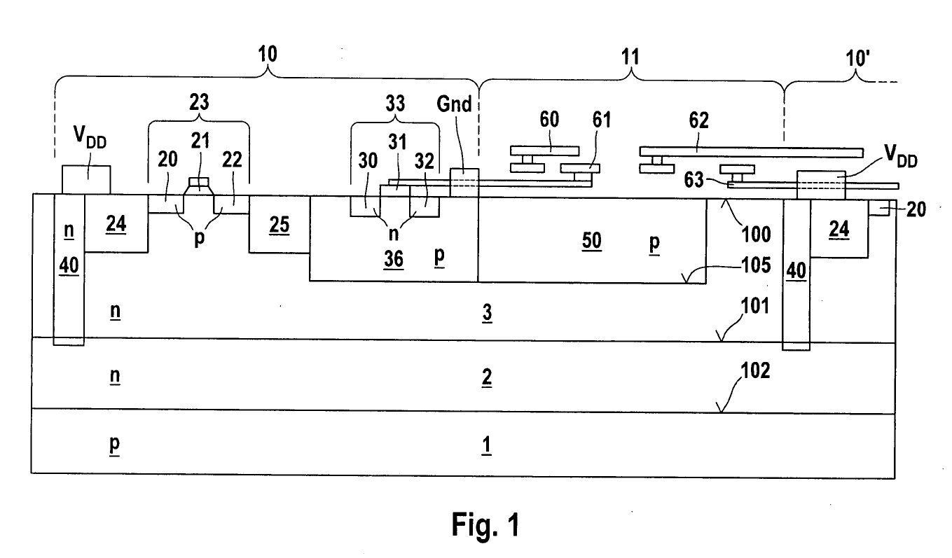

FIG. 1 schematically shows a partial section of an embodiment of the present invention. FIG. 1 shows a p-doped substrate 1. An n-doped layer 2 is applied to surface 102 of substrate 1. Layer 2 is hereinafter referred to as a buried layer. An n-doped first layer 3 is applied to buried layer 2. A plurality of structures is applied to upper surface 100 of first layer 3, facing away from substrate 1. The structures may be subdivided into two types according to their function: Standard cells 10 and wire channels 11. Standard cells 10 are arranged along a lateral direction. Parallel to a row of standard cells 10, there are additional standard cells 10′. In FIG. 1, this lateral direction is a direction perpendicular to the plane of the drawing. Wires 60 through 63 of standard cells 10 are mainly located in wire channels 11, which are laterally separated from the standard cells. The wires run above upper surface 100 of first layer 3. The arrangement of standard cells 10 in rows is shown as an example. Any lateral arrangement is conceivable; the only essential feature is that wire channels 11 are spatially separated from standard cells 10.

A standard cell 10 of the example embodiment depicted has a MOSFET n-channel 23 and a MOSFET p-channel 33, a positive voltage source V_{DD} and a ground Gnd. MOSFET n-channel 23 has two p-doped regions 20, 22 embedded in upper surface 100 of n-doped layer 3, a gate structure 21 being applied over a region between the two p-doped regions 20 and 22. Furthermore, two other n-doped regions 24 and 25, which adjoin p-doped regions 20 and 22 in the lateral direction, are embedded in n-doped substrate 3. To manufacture a MOSFET p-channel having two n-doped regions 30 and 32 and a gate region 31, which is located above the region between the two n-doped regions 30 and 32, in a first step a p-doped trough 36 is introduced into n-doped layer 3. n-doped regions 30 and 32 are introduced into this trough, there being a p-doped material between the n-doped regions.

Voltage supply V_{DD} takes place in a contact region which is applied to surface 100 and is conductively connected to n-doped region 24. The ground connection is implemented via a second contact, which is also applied to surface 100 and is in contact with p-doped trough 36.

The contact region of voltage supply V_{DD} is connected to a buried, highly n-doped layer 2 via a-vertical n-doped connection 40 (“sinker”), layer 2 adjoining n-doped layer 3 at surface 101 facing away from upper surface 100. Buried layer 2 adjoins a p-doped substrate 1 by a boundary surface. A barrier layer 102 is formed on this boundary layer. Barrier layer 102 has a capacitance which is proportional to the surface area of barrier layer 102. The n-doped surface of the capacitance of barrier layer 102 is connected to voltage supply V_{DD} via vertical connection 40. Vertical connection 40 is to be produced in such a way as to have high conductivity and low inductivity. This makes it possible to stabilize positive voltage supply V_{DD}.

A second barrier layer 103 is formed between the boundary layer of p-doped trough 36 and n-doped layer 3. The reverse polarity of the second barrier layer makes its use for stabilizing ground supply Gnd possible. However, it is disadvantageous that second barrier layer 103 has a small surface area. The surface area is limited by the dimensions of p-doped trough 36.

The design of standard cells 10 should be as compact as possible to enable a number of standard cells 10 to be installed in a component on the smallest possible surface. Therefore the MOSFET p-channel is designed in such a way that it has the smallest possible surface area, i.e., in the libraries p-doped trough 36 has the minimum possible dimensions necessary for implementing a MOSFET p-channel. Enlarging p-doped trough 36 to achieve a greater barrier layer 103 would increase the lateral dimensions of each standard cell 10. However, the increased space requirement is not desirable.

In an example embodiment of the present invention, another p-doped region 50 is introduced into n-doped layer 3 next to region 36. This region is referred to hereinafter as a stabilization region. Stabilization region 50 is advantageously located underneath wire channel 11. Typically n-doped layer 3 is not structured underneath wire channel 11. Barrier layer 103 is extended by barrier layer 105 due to the contact of stabilization region 50 with p-doped trough 36. As a result, the capacitance of the barrier layer increases, allowing better stabilization of ground supply Gnd.

Introducing stabilization region 50 underneath wire channel 11 is not equivalent to directly enlarging trough 36. The essential advantage is that, for the methods typically used in designs using circuit libraries, the design of the standard cells is not modified, and therefore these preserve their minimum dimensions. Furthermore, introducing stabilization region 50 underneath wire channel 11 requires no modification in the design process for wires 60 through 63. This is based, among other things, on the fact that no structures were previously introduced into first layer 3 underneath wire channel 11. The design of p-doped stabilization regions 50 is therefore compatible with the typical method steps of semiconductor technology and may be integrated therein.

Since the surface area of barrier layer 105 is decisive for the capacitance of barrier layer 105, p-doped stabilization region 50 may be structured laterally and/or vertically in a further example embodiment of the present invention. The design is advantageously such that the surface area of p-doped stabilization region 50 is as large as possible, yet it forms a contiguous region. In a possible design, p-doped stabilization region 50 is provided with a plurality of plates which are in contact with p-doped trough 36. Furthermore, p-doped stabilization region 50 may be buried in n-doped layer 3, p-doped stabilization region 50 being in contact with p-doped trough 36.

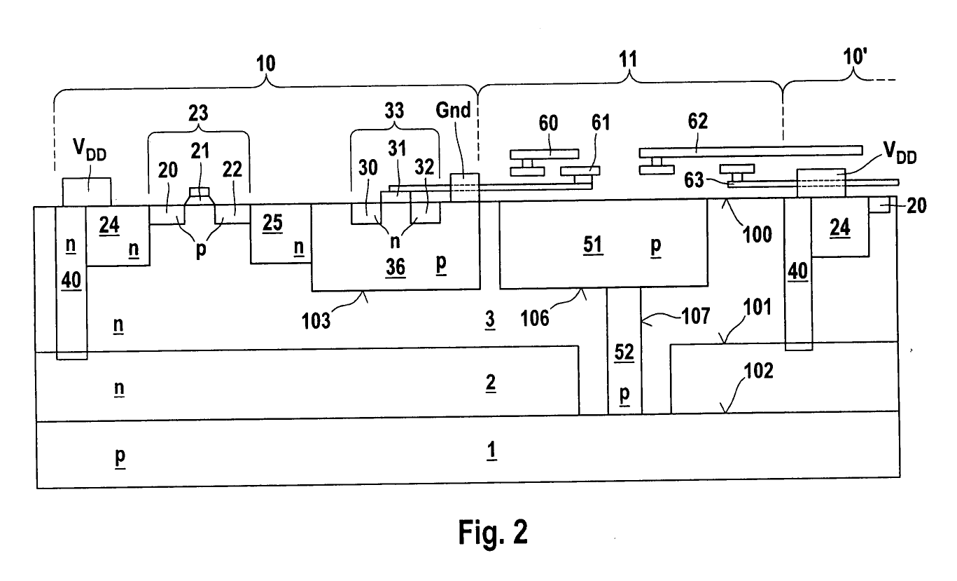

FIG. 2 schematically shows a partial section of another example embodiment of the present invention. This embodiment also has standard cells 10 and wire channels 11. A p-doped stabilization region 51 is introduced in n-doped region 3 underneath wire channel 11. This p-doped stabilization region 51 is not in contact with p-doped trough 36 of MOSFET p-channel 33. p-doped stabilization region 51 is connected to p-doped substrate 1 via a vertical p-doped connection 52. A barrier layer 106 is formed between p-doped stabilization region 51 and n-doped layer 3. The capacitance of the barrier layer capacitively couples the potential of p-doped substrate 1 to the potential of n-doped first layer 3. Since substrate 1 has a large charge reservoir and a stable potential, the potential of first layer 3 is thus stabilized. First layer 3 is in turn in direct contact with voltage supply V_{DD} or, even more directly, with the MOSFET n-channel, so that voltage fluctuations of supply V_{DD} are reduced. In this way, p-doped stabilization region 51, which is connected to substrate 1 via vertical connection 52, stabilizes positive voltage supply V_{DD}. As FIG. 2 shows, p-doped stabilization region 51 may be designed as a trough, but it may also be structured both laterally and vertically to achieve the largest possible surface area of barrier layer 106. Vertical p-doped connection 52 also forms a barrier layer 107.

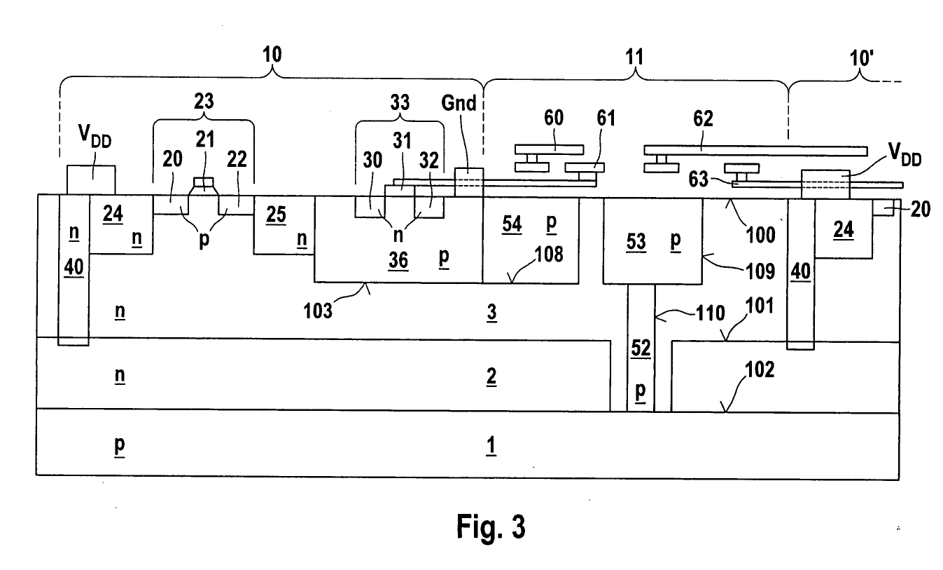

FIG. 3 schematically shows a partial section of another example embodiment of the present invention. This embodiment has a p-doped stabilization region 54, which adjoins p-doped trough 36 of the MOSFET p-channel. As described with reference to FIG. 1, this p-doped stabilization region 54 is embedded underneath the connections. As described with reference to FIG. 1, it supports ground supply Gnd. In addition, a second p-doped stabilization region 53, which is connected to p-doped substrate 1 via p-doped vertical connection 52, is embedded underneath wires 11. As described with reference to FIG. 2, p-doped stabilization region 53 stabilizes the potential of n-doped region 3 and thus also voltage supply V_{DD}. The region of layer 3, which is directly underneath wiring 11, is designed in such a way that the supply (voltage supply V_{DD}, ground supply Gnd) is more highly stabilized due to the fact that stabilization region 53 or 54 assumes a larger volume depending on which of the two supplies is exposed to a greater load.

Although the present invention was described above with reference to exemplary embodiments, it is not limited thereto, but may be modified in many ways.

The conductivity types of the layers may be replaced by the opposite type of conductivity in each case. It is conceivable to support a negative voltage supply among other things.

The present invention is not limited to components having standard cells composed of two transistors. These were selected as examples only for the sake of simplicity. The standard cells may also be composed of a plurality of transistors and/or passive components.

1-7. (canceled)

8. A semiconductor device, comprising:
a first layer of a first conductivity type;
a substrate of a second conductivity type;
a buried layer of a first conductivity type interposed between the first layer and the substrate; and
at least two standard cells having active components being situated in first lateral regions, wherein each standard cell has at least one transistor of the first conductivity type and at least one transistor of the second conductivity type, the transistor of the second conductivity type being introduced into the first layer, and the transistor of the first conductivity type being introduced into a trough made of a semiconductor material of the second conductivity type, the trough being introduced into the first layer, and wherein each standard cell is supplied via a voltage supply, a first polarity of the voltage supply being applied to a first contact that is conductively connected to the first layer, and the second polarity of the voltage supply being applied to a second contact that is conductively connected to the trough;
a plurality of wires extending in second lateral regions above the first layer for connecting the at least two standard cells, wherein no active components are situated in the second lateral regions; and
at least one of a first stabilization region and a second stabilization region made of a semiconductor material of the first conductivity type being embedded in the first layer within each of the second lateral regions, wherein barrier layer capacitance is formed on a boundary surface between each stabilization region and the first layer, and wherein at least one of: a) the first stabilization region adjoins the trough; and b) the second stabilization region is connected to the substrate of the first conductivity type via a vertical connection made of a semiconductor material of the first conductivity type.

9. The device as recited in claim 8, wherein at least one of the first stabilization region and the second stabilization region has a large surface area that occupies a major portion of each corresponding second lateral region.

10. The device as recited in claim 9, wherein at least one of the first stabilization region and the second stabilization region has a plurality of lamellae.

11. The device as recited in claim 8, wherein the first stabilization region and the second stabilization region are buried in the first layer.

12. The device as recited in claim 8, wherein the first stabilization region and the second stabilization region are directly connected to a third contact, and wherein the second polarity of the voltage supply is applied to the third contact.

13. The device as recited in claim 11, wherein the first stabilization region and the second stabilization region are directly connected to a third contact, and wherein the second polarity of the voltage supply is applied to the third contact.

14. The device as recited in claim 11, wherein the first stabilization region and the second stabilization region have a high dopant concentration.

15. The device as recited in claim 12, wherein the first stabilization region and the second stabilization region have a high dopant concentration.

16. The device as recited in claim 11, wherein the first polarity of the voltage supply has a positive potential with respect to the second polarity.

17. The device as recited in claim 12, wherein the first polarity of the voltage supply has a positive potential with respect to the second polarity.
